(19) United States
(12) Patent Application Publication
(10) Pub. No.: US 2004/0141676 A1
(43) Pub. Date: Jul. 22, 2004

(54) Integrated optical spectrometer with high spectral resolution in particular for high-speed telecommunications and metrology and a method for manufactruing same

(76) Inventors: Michel Bugaud, Argenteuil (FR); Sylvain Magne, Fontenay-aux-roses (FR); Gilles Grand, Genoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/471,749

(22) PCT Filed: Mar. 26, 2002
(86) PCT No.: PCT/FR02/01042

(30) Foreign Application Priority Data
Mar. 27, 2001 (FR) 01/04080

(51) Int. Cl. G02B 6/12

(52) U.S. Cl. 385/14

(57) ABSTRACT

This spectrometer comprises at least one elementary spectrometer that comprises an optical phase array comprising a microguide assembly (12) and formed on a cleaved planar optical guide (14), reflecting means (24, 30, 32, 34) capable of successively reflecting radiation sent from the microguide assembly, for propagating this radiation in the folded form and in free space, means (26) for photodetecting the radiation so reflected and means (28) for focusing radiation on said photodetection means.

### TECHNICAL FIELD

The present invention relates to an optical spectrum analyzer also called “spectral analysis device” or, more simply, an “optical spectrometer.”

This spectrometer is particularly applied to infrared radiation in the field of high-speed optical telecommunications, for example. Other applications of the invention, in particular optical metrology, will be mentioned in the following.

### PRIOR ART

Optical telecommunications has made possible a considerable increase in information rates by virtue of spectral and temporal coding. Currently, rates of the order of 40 gigabit per second are obtained on one single optical fiber. Thanks to DWDM or dense wavelength division multiplexing, the information rate exceeds 1 terabit per second.

The increase in speeds that is necessary for establishing information transfer protocols (in particular on the Internet), requires a simultaneous growth in the spectral width of the telecommunications band and a reduction of the spectral interval between channels.

This process is limited by the wavelength routing capacities, by the available power for the amplifiers and by the non-linear effects such as the stimulated Raman effect, the stimulated Brillouin effect and above all, the four-wave mixing that constitutes a limit for wavelength separation.

It is common to consider three spectral windows.

The first is situated at around 800 nm; it is utilized for local networks using multimode fibers.

The second spectral window is situated at around 1,280 nm to 1,350 nm (corresponding to a dispersion minimum in the silica); it is currently little used because the optical amplifiers having fibers doped with praseodym (PDFA), which were developed for this window have never attained the performance levels of the erbium doped fiber amplifiers (EDFA) for the 1.55 μm band.

The third window is situated at around 1,550 nm (corresponding to an attenuation minimum for silica); it is currently broken down into several bands according to the optical amplifiers used. The C-band is the spectral band amplified by the conventional EDFA optical amplifiers; it extends from 1,528 nm to 1,565 nm and thus across 37 nm. The L-band extends from 1,561 nm to 1,620 nm; thus over 59 nm and corresponds to EDFA optical amplifiers using Raman amplification.

Currently, the transmission wavelengths in C-band are defined by the ITU; that is, the International Telecommunications Union along a spacing of 100 GHz (0.8 nm). That, which is called the ITU grid, in other words, the set of wavelengths defined by the ITU, begins at 1528.77 nm (196.1 THz) up to 1563.86 nm (191.7 THz). It comprises 45 wavelengths that extend over approximately 36 nm. The growth of requirements in terms of transmission capacity makes development of an inter-channel spacing of 0.4 nm (50 GHz) probable, although the non-linear effects currently limit the transmission range.

Novel optical amplifiers using fibers doped with thulium (TDFA) make it possible to cover the spectral range that extends from 1,470 nm to 1,500 nm. This range, which is currently called the S-band thus completes the third window (the spectral band situated at 1,510 nm±10 nm comprising monitoring channels).

With a view of increasing the spectral transmission capacity, optical amplifiers using stimulated Raman effect amplification mechanisms are being studied. In this type of amplifier, amplification is provided in distributed fashion and not point-wise (as is the case in the EDFA amplifiers).

The noise figures obtained by utilizing Raman amplification are better than those obtained using EDFA amplifiers, which makes it possible to reduce the optical power transmitted and thus reduce the spectral interval between channels. Furthermore, in contrast with EDFA amplifiers, which allow only C-band amplification, the stimulated Raman effect amplifiers make it possible to amplify a much larger spectral band by using an adapted assembly of pumping lasers.

In theory, a Raman amplifier can thus cover all of the wavelengths between 1,300 nm and 1,660 nm; in other words, much more than the bands currently covered by doped fiber amplifiers.

Thus the actual DWDM transmission spectrum extends over a hundred nanometers (C- and L-bands) for a spectral separation between channels of 0.8 nm. Now, it is believed that the TDFA amplifiers can be improved for the S-band, which makes it possible to cover a total spectral band of approximately 150 nm (S-, C-, and L-bands).

The increase of DWDM capacity thus makes it possible to envision the appearance of Raman amplifiers that are compatible with the existing optical grid and for which the total spectral range reaches more than 350 nm; hence a total of almost 900 channels per optical fiber (for an inter-channel separation of 0.4 nm) instead of scarcely a hundred at the present time.

In order to efficaciously manage the separation of telecommunication channels, it is thus necessary to utilize optical spectrum analyzers making it possible to cover all of the aforementioned spectral ranges and to precisely identify the channels in order to determine their occupation.

In particular, it is important to provide an optical spectrum analyzer in order to verify the wavelength attributions and maintain a low error rate over all of the channels. It is also important to measure the intensity of the optical signals with a satisfactory signal to noise ratio.

For telecommunications operators, it is desirable to design a compact, portable, cost-optimized spectrometer that makes it possible to analyze the spectral content of the ITU grid and to verify the position in wavelength (in order to analyze any deviation) as well as the power of each of the channels.

Moreover, it is desirable that the resolving power of this spectrometer be approximately equal or greater than 30,000 and that the wavelength range observed makes it possible to satisfy the future pass-band (between 120 nm and 180 nm). The total number of measurement points is thus at least of the order of 2,400 to 3,600 and preferably close to 7,200.

This type of spectrometer becomes vital for future DWDM grids and would be broadly used for optical controls on each node of a network comprising a wavelength add-drop device, a terminal or an amplifier.

The commercially available spectral analysis devices making it possible to observe the spectrum defined according to the norms defined by the ITU, are single or double-pass diffraction grating spectrometers, scanning Fabry-Perot interferometric cavities in free space or Fourier transform spectrometers based on Michelson interferometers.

All of these known devices are expensive, require large amounts of space and are fragile. Moreover, their working frequencies are approximately equal or less than 100 Hz and they do not make it possible to assure a resolving power of greater than 30,000 over more than 40 nm.

Furthermore, certain known multiplexers/demultiplexers could be utilized as optical spectrum analyzers but these devices do not make it possible to perform measurements of optical spectra and execute only those multiplexing functions compatible with the standard ITU 50 GHz.

The same applies to the devices utilizing the diffraction gratings etched on planar substrates.

Moreover, these known devices do not make it possible to directly determine the Bragg wavelengths having a sufficiently elevated precision.

It would be desirable to have an optical spectrometer with the following properties:

separation into a wavelength better than the inter-channel spacing (0.4 nm); in other words, at least 0.05 nm (spectrometer resolving power greater than 30,000);

large analytical spectral band for an optical spectrum (at least 120 nm or even 360 nm), the number of significant points being at least 2,400 and extensible to 7,200;

the possibility of integration (for example, in a portable housing);

low cost;

high measurement dynamics;

large frequency pass-band (several kilohertz or more);

independence vis-à-vis the temperature and atmospheric pressure (which are capable of inducing index of refraction variations), and

independence vis-à-vis the polarization of the light.

Optical components are already known, called phasars or optical phase arrays. On the subject of these components, which are also known as AWGs (for “arrayed waveguide gratings”), reference can be made to the following document:

[1] European patent application for a Phased array device or phasar and process for manufacturing this device, published under N^{o} EP 0911660 A, an invention by G. Grand et al. —see also U.S. patent application filed on 26 Oct. 1998 under Ser. N^{o} 09/179,133.

Other phasars are also known from:

[2] M. Zirngibl, C. H. Joyner and J. C. Centanni, Size reduction of waveguide grating router through folding back the input-output fanouts, Electron. Lett. Vol. 33, N^{o} 4, 1997, pages 295-297.

### PRESENTATION OF THE INVENTION

The object of the present invention is to remedy the aforesaid drawbacks and provide optical spectrometers wholly or partially having the aforementioned qualities and in particular the capability of separating wavelengths that are very close to each other, a broad operating spectral band and the possibility of requiring little space and obtained in integrated form in order to be portable.

More precisely, the object of present invention is an optical spectrometer comprising at least one elementary optical spectrometer, this elementary optical spectrometer being characterized in that it comprises:

an optical phase array comprising an assembly of microguides, this optical phase array being formed on a cleaved planar optical guide;

reflecting means capable of successively reflecting the radiation issuing from the microguide assembly with a view of propagating of this radiation in folded form in free space;

means for photodetecting the radiation so reflected, and

means for focusing the radiation on the photodetection means.

Preferably, the reflecting means are capable of making possible propagation of the radiation in folded form, initially in the planar optical guide then in free space, above this planar optical guide, in a plane that is parallel to the latter.

According to a first particular embodiment of the optical spectrometer that is the object of the invention, the optical phase array is intended to function by reflection and the planar optical guide comprises a plurality of cleaved sides, which are made reflecting vis-à-vis radiation issuing from the microguide assembly and vis-à-vis radiation intended to penetrate into this assembly.

In this case, according to a preferred embodiment, the microguide assembly abuts on one of the cleaved sides and the optical phase array comprises a focusing zone that abuts on at least one of these cleaved sides.

According to a variant of the first particular embodiment, the optical phase array is provided for functioning by reflection and the planar optical guide comprises a cleaved side that is made reflecting vis-à-vis radiation coming from the microguide assembly and vis-à-vis the radiation intended to penetrate into said assembly and at which the microguide assembly abuts, as well as other cleaved sides capable of reflecting this radiation, this radiation being provided for arriving on these other cleaved sides with angles of incidence sufficiently large to result in total reflection of this radiation.

One of the advantages of this variant resides in the fact that these other sides, deprived of reflector treatment, do not induce any polarization of the light that they reflect.

In the optical phase array, the microguides form, for example, concentric arcs of circles.

According to a second particular embodiment, the optical phase array is provided to function by transmission.

According to a preferred embodiment of the invention, the reflecting means comprise:

a prism, which is intended to reflect the radiation coming from the microguide assembly into a plane parallel to the planar optical guide on which the optical phase array is formed, and

at least one mirror intended to reflect the radiation propagating in this plane towards the photodetection means.

The optical spectrometer that is the object of the invention can comprise in addition a support, on which the optical phase array, the reflecting means and the photodetecting means are positioned relative to each other.

Preferably, this support is obtained by molding or hot pressing a plastic material, starting with a mold obtained by a lithography and electro-forming molding technique.

Preferably, the optical spectrometer that is the object of the invention comprises, in addition, means for compensation of changes undergone by the optical phase array due to temperature variations.

In the case of the preferred embodiment utilizing at least one mirror, these compensating means comprise, preferably, a bar having a preferably elevated thermal expansion coefficient, said bar and mirror being made interdependent in order to cause, by thermal expansion, modifications in the orientation of the mirror capable of compensating for the changes undergone by the optical phase array.

Preferably, the planar optical guide is obtained by an integrated optics method on glass or on a semiconductor, in particular on silicon or indium phosphide.

A further object of the present invention is an optical spectrometer comprising a plurality of elementary optical spectrometers according to the invention, intended for covering in modular fashion a defined spectral range and optically coupled to an input optical fiber by means of wavelength separation means.

According to a first particular embodiment, this spectrometer comprises in addition polarization separation means that connect these wavelength separation means to the elementary optical spectrometers.

According to a second particular embodiment, this spectrometer comprises in addition, power separating means and polarization means that connect these wavelength separation means to the elementary optical spectrometers.

The present invention relates also to an advantageous method for manufacturing the spectrometer that is the object of the invention, wherein the optical phase array is of a folded type for functioning by reflection and manufactured in several copies in head-to-foot pairs according to techniques of integrated optics using the same substrate that is then cleaved in order to obtain the various optical phase arrays so fabricated and to form an elementary optical spectrometer using each one of these.

In order to manufacture the spectrometer that is the object of the invention, each optical phase array can be formed from a substrate and cleavage marks can be formed at the same time as the microguides of the phase array on this substrate.

The present invention further relates to a spectral analysis device for high-speed optical telecommunications utilizing dense wavelength division multiplexing, this device comprising the spectrometer according to the invention that comprises a plurality of elementary optical spectrometers in order to provide an indication in real time of positioning of channels in the interval running from 1528.77 nm to 1563.86 nm in modular form and adaptable according to the needs of the users.

The present invention also relates to a Bragg array optical metrology device, this device comprising the spectrometer according to the invention, which comprises the plurality of elementary optical spectrometers in order to measure the Bragg wavelength.

This spectrometer is, for example, for detecting the optical signals coming from at least one Bragg grating sensor.

According to different aspects of the invention:

the dispersive device that comprises the elementary optical spectrometer is a component of integrated micro-optics called optical phase array or even phasar that comprises a plurality of wave guides each one of which introduces phase changes relative to that which precedes it; such a phasar causes a mono-dimensional assembly of electrical signals (forming a vector), this assembly being representative of the optical spectrum of the light injected into the input fiber of the elementary spectrometer;

a spectrometer according to the invention can comprise one or a plurality of elementary spectrometers mounted in parallel, arranged in multiple stages; the optical spectrum sought is then obtained by concatenating all of the elementary spectra coming from each of the phasars; this assembly in parallel makes it possible to resolve the physical contradiction between obtaining a satisfactory spectral resolution (that is, a heavy dispersion), of a large spectral range and minimal space occupation for the spectrometer;

in addition, in order to minimize space requirements, each phasar can be a phasar functioning on transmission or a “folded” demi-phasar (for functioning on reflection) by virtue of an interface forming a mirror, disposed in the zone of the phase change microguides;

in addition, the adaptation of the dispersion properties of the phasar to the dimensions of the photodetector bars results in “folding” the focusing zone a plurality of times so that the size of the optical circuit formed remains compatible with the known techniques for manufacturing and optimized for reducing its cost in the context of collective manufacture;

means for auto-compensating variations of temperature, utilizing the “folding” of the light beam treated, can be provided.

One may note the originalities of various aspects of the invention with respect to known optical spectrometers:

according to one of its designs, the optical spectrometer of the invention comprises “folded” demi-phasars at the level of the microguides by an interface forming a mirror and the focusing zone is thus identical for the input and the output (in contrast with classical phasars);

the focusing zone can also be “folded” in part over the substrate where it is formed and also in free space, using optical means assembled on a support preferably obtained by preforming according to the so-called LIGA method, this support being capable of accommodating temperature auto-compensation means;

a plurality of phasars or demi-phasars formed on planar substrates can be used mounted in parallel, arranged in multiple stages, making it possible to increase the spectral range covered by concatenation of the vector-spectra obtained.

This type of multi-stage optical spectrometer with “folding” makes it possible to resolve the problems posed in the field of DWDM telecommunications.

The following advantages can be obtained by virtue of the invention:

a resolving power greater than 30,000 (resolution of 50 pm that can be improved by centroid treatment);

modulable spectral range by multiples of 40 nm, from 40 nm to 360 nm;

measurement dynamics (diaphony) of the order of −30 dB (by virtue of the phase grating);

significant signal-to-noise ratio (by virtue of parallel spectral analysis)

significant bandwidth (greater than 1 kHz);

independence vis-à-vis polarization;

independence vis-à-vis temperature (by virtue of a mechanical auto-compensation or thermal stabilization);

miniaturization (made possible by planar substrates and also by multi-stage layout);

spectrometer adapted to utilization on the ground;

optimized manufacturing cost (made possible by collective manufacture in integrated optics) and large series production of the housing support (by virtue of the use of the LIGA method).

### BRIEF DESCRIPTION OF THE DRAWINGS

The present invention will be better comprehended when reading the descriptions of exemplary embodiments given hereinbelow purely illustratively and non-limitingly, with reference to the appended drawings, wherein:

FIG. 1 represents a block diagram of a DWDM spectrometer according to the invention;

FIG. 2 represents a block diagram of another DWDM spectrometer according to the invention utilizing polarization separators;

FIG. 3 is a block diagram of another DWDM spectrometer according to the invention utilizing optical fiber polarizers;

FIG. 4 diagrammatically represents an example of the masking scheme of an integrated optics demi-phasar on glass that can be utilized in the invention;

FIG. 5 is an optical diagram corresponding to the demi-phasar represented in FIG. 4;

FIG. 6A is a diagrammatic view of an assembly of an elementary micro-spectrometer according to the invention, utilizing the so-called LIGA (for “Lithographie Galvanoformung Abformung”) process;

FIG. 6B is the section AA of FIG. 6A;

FIG. 7A is a diagrammatic view of an assembly of another elementary micro-spectrometer according to the invention, also utilizing the LIGA process;

FIG. 7B is the section AA of FIG. 7A;

FIG. 8 diagrammatically represents a passive auto-compensation mechanism of the thermal dependence of a phase grating that can be used in the invention;

FIG. 9 diagrammatically represents another passive auto-compensation mechanism of the thermal dependence of a phase grating that can be used in the invention;

FIG. 10 diagrammatically represents an example of masking scheme of two demi-phasars on integrated optics on glass that can be used in the invention;

FIG. 11A is a diagrammatic view of an assembly of another elementary micro-spectrometer according to the invention utilizing the LIGA process;

FIG. 12 diagrammatically represents an application of a device according to the invention to the measurement of deformations, of pressures and of temperatures using the Bragg grating forming transducers, and

FIG. 13 diagrammatically represents an 8-inch (approximately 20 cm) wafer of silica integrated optics on silicon as well as an example of the masking scheme of phasar components according to the elementary mask described by making reference to FIG. 10.

### DETAILED DESCRIPTION OF PARTICULAR EMBODIMENTS

An object of the present invention is the realization of a compact, cost-optimized spectrometer that makes it possible to cover the useful spectrum for the third telecommunications window (conventional band or C-band, and long band or L-band). The spectral band to be covered in order to satisfy the current telecommunications market is of the order of 120 nm. Furthermore, the current ITU grid is 50 GHz, which corresponds to a separation of about 0.4 nm between channels (the number of channels being equal to 300).

An essential area of application of this high-resolution and wide range spectrometer is that of very high spectral density telecommunications (utilizing the DWDM method).

In the present invention, phasars are used for reasons of dispersion (the phasars having an elevated order of diffraction), compacity and diaphony performance. However, dimensioning calculations demonstrate that it is not easy to manufacture a single phasar for the entire wavelength range because the number of microguides required to satisfy the spectral resolution criteria is very high: it is greater than 2,500.

Furthermore, the dimensioning of this type of component results in an output focal distance number much greater than the size of a semiconductor wafer. This is why, in the invention, it is preferred to “fold” the beam diffracted by the microguides one or more times in the zone of focusing and to mount a plurality of phasars in parallel using a multi-stage approach (stacking) in order to cover the integrality of the spectrum of the C and L bands by placing them end-to-end, using a computer, the information respectively coming from phasars.

A particular embodiment of a phasar that can be used in the invention and functions at an order of 39 for a spectral range of 40 nm will now be described. Other particular embodiments are possible; one of these latter comprising, for example, working at an order of 78 over a spectral range of 20 nm.

A phasar behaves as a concave diffraction grating on transmission, whose equation is written:

$${n}_{s} \cdot ( sin {θ}_{i} + sin {θ}_{o} ) = n \cdot \frac{λ}{{d}_{g}} - {n}_{c} \cdot \frac{Δ L}{{d}_{g}} = n \cdot \frac{( λ - {λ}_{o} )}{{d}_{g}}$$

In this equation, d_{g} is the interval between two microguides at the entry of the output focusing zone, nₛ is the index of the planar guide, n_{c} is the index of the guide (which is frequently the same), the angles θ₁ and θ₀ are the diffracted angles, respectively in the input focusing zone and in that of the output. ΔL is the length offset from one guide to the other, and n is the diffraction order. The wavelength λ₀ is the central wavelength of the phasar that is written:

$${λ}_{o} = \frac{{n}_{c} \cdot Δ L}{n}$$

For a demi-phasar (folded in reflection), the equation is modified by replacing ΔL with 2.ΔL:

$${n}_{s} \cdot ( sin {θ}_{i} + sin {θ}_{o} ) = n \cdot \frac{λ}{{d}_{g}} - {n}_{c} \cdot \frac{2 \cdot Δ L}{{d}_{g}}$$

The phasar makes it possible to demultiplex wavelengths coming from one of the input guides towards the output guides. The phasar makes it possible to perform this function using any input guide; the spectrum received at the output is then offset in proportion to the placement of the concerned input guide.

This property can be used in order to realize a temperature auto-compensation by affixing the input optical fiber on a mechanical support whose displacement induced by thermal expansion compensates for the spectral offset due to the thermal dependence of the component.

In the invention, this property can also be applied to the case of utilization of a demi-phasar (folded) in order to offset an input fiber of a photodetector bar arranged in an identical plane, as will be seen in the following.

The dimensioning of a phase grating for applications of the spectrometer initially requires adjustment of the maximum possible diffraction order (and length offset between each microguide) by taking into account the observed spectral range (without overlap of one order on a following or preceding order), then the minimum number of microguides is chosen in order to assure the desired resolving power. To finish up, the output focal distance is calculated as a function of the photodetector bar characteristics.

In order to suppress any ambiguity, the spectral overlaps of one order i over another following i+1 or preceding i−1 order are prevented. In order to do this, the free spectral interval, called ISL, is chosen to be at best equal to (or greater than) the observed spectral range, called ES. This defines a condition relating to the diffraction order of the phasar:

$$n = \frac{{λ}_{i}}{{λ}_{i} - {λ}_{i + 1}} = \frac{{λ}_{i}}{ISL} < \frac{{λ}_{i}}{ES}$$

The resolving power of the phasar is written

$$\frac{λ}{Δ λ} = n \cdot M$$

wherein n is the order of diffraction and M is the number of microguides. Δλ corresponds to the spectral width of the “Airy's spot”; one wants to have 0.05 nm in order to be able to distinguish the channels in the ITU grid.

The length offset between each microguide is equal to

$$Δ L = \frac{n}{2 \cdot {n}_{c}} \cdot {λ}_{o}$$

for the demi-phasar and to

$$Δ L = \frac{n}{{n}_{c}} \cdot {λ}_{o}$$

for the whole phasar.

By way of example, the microguides are constituted by the arcs of a circle.

In the case of the demi-phasar, for example, an angle of 60° for these arcs of a circle and the relation between the length offset and the ray offset ΔR is written:

$$Δ R = \frac{3}{π} \cdot Δ L ;$$

by way of example, for the whole phasar (angle of 120°), the ray offset ΔR is written

$$Δ R = \frac{3}{2 \cdot π} \cdot Δ L .$$

The dispersion relation that links the displacement Δy of the focal spot at the output of the microguides to the wavelength λ is written:

$$Δ y = \frac{n \cdot f}{{d}_{g} \cdot {n}_{s}} \cdot λ$$

wherein nₛ is the effective index of the focusing zone and f is the length of this zone that corresponds to the output focal distance.

If one takes into account all of the spectral length observed, the focused length L corresponding to the useful length of the bar, it is found that this length L differs little from the quantity

$$\frac{n \cdot f}{{d}_{g} \cdot {n}_{s}} \cdot ISL$$

itself differing little from

$$f \cdot \frac{λ}{{d}_{g} \cdot {n}_{s}}$$

and the focal distance f thus differs little from

$$\frac{{n}_{s} \cdot {d}_{g}}{λ} \cdot L .$$

The interval d_{g} cannot be reduced as much as desired; it is limited by the diaphony between the guides. As this value is fixed, the focal distance depends only on the length of the bar. On the other hand, the focal distance in the glass (index 1.46) is grater than the focal distance in air (index 1) due to the fact of auto-focus at the output of the planar guide.

Any diminution of the spectral length observed is not reflected relative to the focal distance because it is compensated by a proportionally low diffraction order (the ISL being adjusted as a consequence). Obtaining a better spectral resolution requires a novel optical design that is detailed in the present description, said conception making possible a greater geometrical course.

Purely illustrative and non-limitingly, the characteristics of each demi-phasar are given below:

free spectral interval: 40 nm;

diffraction order: 39;

number of microguides: 800;

spacing between microguides: 19.8 μm;

length variation between microguides: 20.7 μm;

width of the diffraction spot: 0.05 nm;

pixel spacing: 13 μm;

number of pixels per bar: 1,024 pixels;

bar length (useful) : 13.3 nm;

spectral resolution (bar): 40 nm/1,024 pixels; in other words approximately 0.04 nm/pixel;

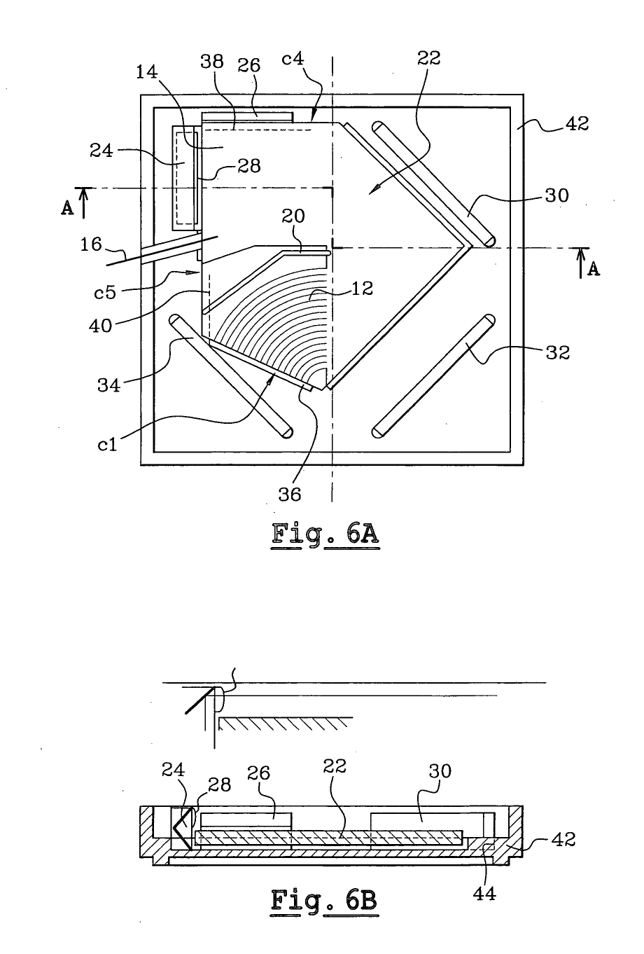

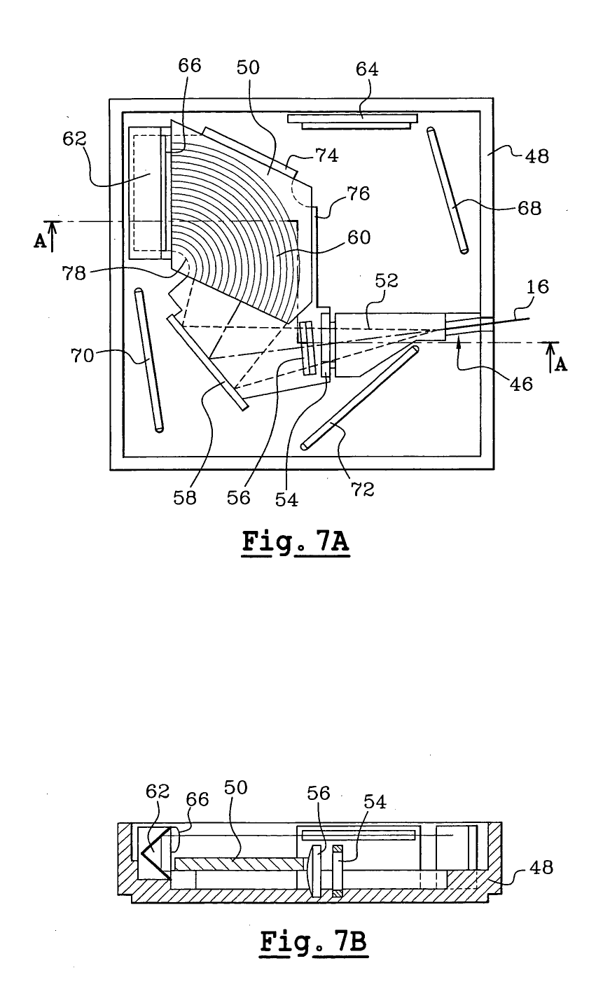

output focal distance: 250 nm in glass (index 1.46), whereby a 50 mm path in glass added to 140 mm in air (equivalent to 200 mm in glass) [an example that applies to the assembly represented in FIGS. 6A and 6B] or even 175 mm in air [example that applies to the assembly represented in FIGS. 7A and 7B].

The characteristics take into account the necessary adaptation between the width of the diffraction spot and the spectral width shown in the photo-detector bar (here, approximately 50 pm per pixel). The realization of a mask by the beam propagation method takes into account the dispersion of the materials used in the precise definition of the optical dimensioning of the component to be realized.

We will now consider the operating principle of a micro-spectrometer according to the invention.

Four embodiments can be distinguished according to which the micro-spectrometer comprises a single phasar or a plurality of phasars (respectively assigned to the distinct wavelength ranges).

(1) single phasar spectrometer (independent of the polarization or corrected by the dependence on polarization);

(2) a phasar-pair spectrometer (for separation of polarization);

(3) a spectrometer comprised of a plurality of elementary phasars (independent of a polarization or corrected by the dependence on polarization), and

(4) a spectrometer comprised of a plurality of elementary phasar pairs (for polarization separation).

The design (1) (respectively (2)) is a special case of the design (3) (respectively (4)). That is why only the designs (3) and (4) will be described in more detail.

The dependence on polarization of a phasar is translated by the overlap of two spectra at the output of this phasar corresponding to two-polarization states (electric transverse, called ET and magnetic transverse, called MT). If the polarization state is not maintained at the output of the optical fiber connection that one wants to analyze (which is the case of classical optical telecommunications connections), the observed spectrum is thus blurred by the overlapping of these two states.

This problem can be resolved in three different ways:

by designing a dispersing device independent of polarization (for example, by means of an ion exchange method on glass);

by designing a dispersing device where the effects of polarization are compensated, for example, by inserting a semi-wave blade in the middle of the phase offset guide zone and, on this subject, reference is made to the following document:

[3] U.S. Pat. No. 5,937,113A,

by separating the two polarization states prior to dispersing by two dispersing components, each state being calibrated for a given polarization state (ET or MT).

This latter approach (design modes (2) and (4)) has the advantage of utilizing phasars of simpler design (without polarization compensation), which are, for example, formed by means of an integrated optics method on silicon and make it possible to realize a spectrometer with controlled polarization. In contrast, it requires fabricating two times more substrates and controlling the polarization stated at the input of these substrates, which considerably complicates the use of this approach and increases the final cost of the device.

The design modes (1) and (2) are respectively identical to the design modes (3) and (4) but without wavelength separator.

The purpose of this wavelength separator is to provide a first separation of the observed bands by each of the elementary micro-spectrometers. This can be a grating demultiplexer of the type that is commercially available under the brand name STIMAX manufactured by Jobin-Yvon or even an integrated optics device such as a commercial phasar.

We consider, by way of example, a micro-spectrometer according to the invention assuring measurement over three spectral ranges.

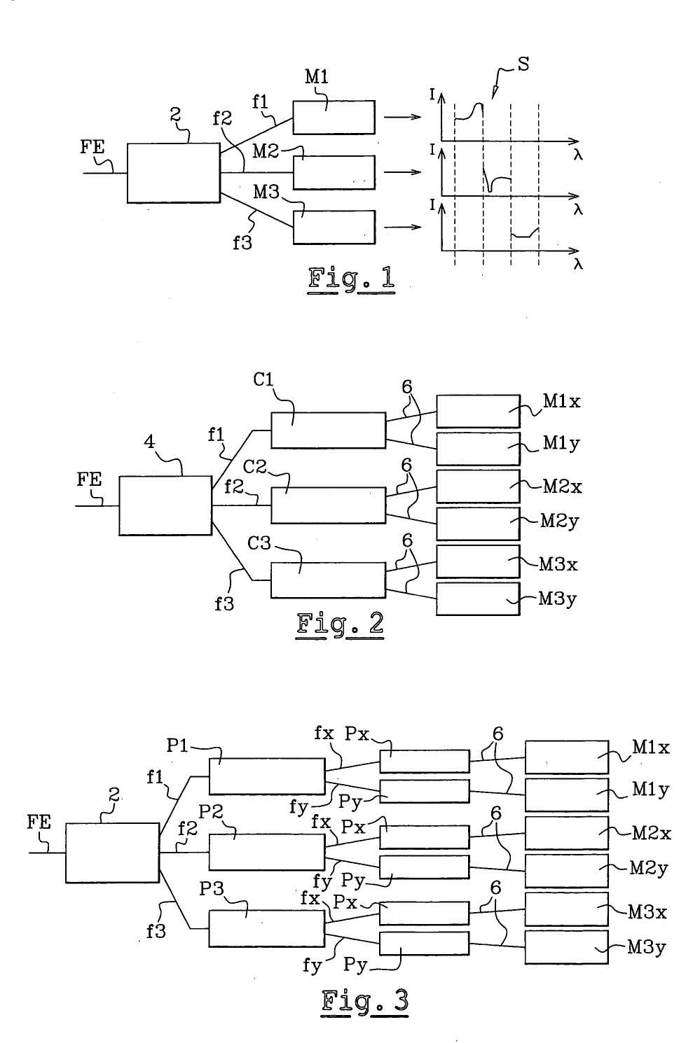

FIG. 1 represents an optical block diagram of such a micro-spectrometer applied to the DWDM method and comprising a wavelength separator 2 as well as three blocks; that is three elementary micro-spectrometers whose references are respectively M1, M2 and M3 according to the design mode (3).

In the right-hand section of FIG. 1 the reconstituted spectrum S is seen with the wavelengths λ on the abscissa and the luminous intensities I on the ordinate.

FIGS. 2 and 3 represent the optical block diagrams of a micro-spectrometer comprised of six blocks; that is six elementary micro-spectrometers, whose references are, respectively, M1x and M1y, M2x and M2y, and M3x and M3y, according to the design mode (4).

This design mode can implement a wavelength separator 4 (for example, a phasar having a pass-band of 40 nm) and three polarization separation couplers C1, C2, C3 (see FIG. 2) that preferably use birefringent crystals for producing the polarization separations, because the diaphony is consequently low.

Another solution (see FIG. 3) consists in using the wavelength separator 2 of FIG. 1, three power separation couplers P1, P2, P3 and six polarizers integrated on fibers; that is, three pairs of polarizers Px and Py, Px allowing polarization in a direction x and Py in a direction y, perpendicular to x.

In the two cases (FIGS. 2 and 3), the optical connection fibers between the polarization separation couplers or the polarizers and the elementary micro-spectrometers are fibers for polarization maintaining fibers 6.

The first neutral axis of each polarization maintaining fiber 6 is positioned parallel to the surface of the substrate on which the associated micro-spectrometer is formed (this surface being, for example, parallel to the direction x).

The second neutral axis of this fiber 6 is positioned perpendicular to this surface (and thus parallel to the y axis in the example being considered).

As to FIGS. 1 to 3, it can be said that the light signal before being analyzed by the micro-spectrometer passes through it via an input optical fiber FE; the wavelength separator 2 (respectively 4) is connected to the elementary micro-spectrometers M1, M2, M3 (respectively to the couplers C1, C2, C3 or P1, P2, P3) via optical fibers f1, f2, f3; each of the couplers P1, P2, P3 is connected to the two associated polarizers Px and Py by two optical fibers fx and fy.

Three possible methods for manufacturing a phasar that can be used in the invention are:

the optical integrated optics on semiconductor method;

or the integrated optics on silicon method;

or the ion exchange on glass method.

We will take into consideration only the methods using a silicon substrate or a glass substrate.

First of all, let us consider a phasar fabricated by an integrated optics method on silicon.

The techniques of the SiO₂/Si genre (guiding layers of SiO₂, SiON, or Si₃N₄) are perfectly adapted to the fabrication of this type of component. The methods used in this case are based on a vapor phase deposition (essentially a vapor phase chemical deposition) or flame hydrolysis and reactive ionic etching for producing patterns.

Let us take the example of the technique utilizing silica or silicon guides. On this subject, we refer to the following documents:

[4) S. Valette et al., Si-based integrated optics technologies, Solid State Tech., 1989, pages 69-74;

[5] S. Valette et al., Silicon-based integrated optics technology for optical sensor applications, Sensors and Act. A, 1990, pages 1097-1091.

In this instance, the optical substrate is a layer of silica of sufficient thickness for isolating the light from the silicon (6 μm for a wavelength of 0.8 μm and 12 μm for a wavelength of the order of 1.3 μm to 1.55 μm), the guiding layer is a layer of phosphor doped silica (with a thickness of 2 μm to 5 μm depending on wavelength) and the covering layer or superstrate is equivalent from the point of view of optical index to the substrate with a thickness of 6 μm to 10 μm.

Typically, for the component described, the dimensions of the channels are of the order of 4 μm×4 μm with germanium oxide doping making it possible to attain a jump of the index of the order of 2×10⁻² in order to assure a considerable confinement of the mode and to limit the diaphony between guides.

Manufacturing a high integration phasar using this method is known. On this subject, reference is made to the following document:

[6] Y. Hibino et al., Fabrication of silica-on-Si waveguide with higher index difference and its application to 256 channel arrayed waveguide multi/demultiplexer, Optical Fiber Communications (OFC) 2000, Baltimore, WH-2-1, page 127.

A more significant index jump of the order of 3×10⁻² can be attained by making a deposit of SiON.

An important advantage of integrated optics on silicon is being able to simultaneously etch V-grooves or U-grooves for positioning the monomodal optical fibers.

On the subject of U-grooves one can refer to the following document:

[7] G. Grand et al., New method for low-cost and efficient optical connection between single-mode fibers and silica guides, Electron. Lett., Vol. 27, N^{o} 1, 1991, pages 16-17.

Another advantage of this technique resides in the control of the slope of the sides of the etching (in order to limit parasite reflection at the ends of the guides, a reflection that generates diaphony).

Let us now consider a phasar fabricated by using an integrated optics on glass method.

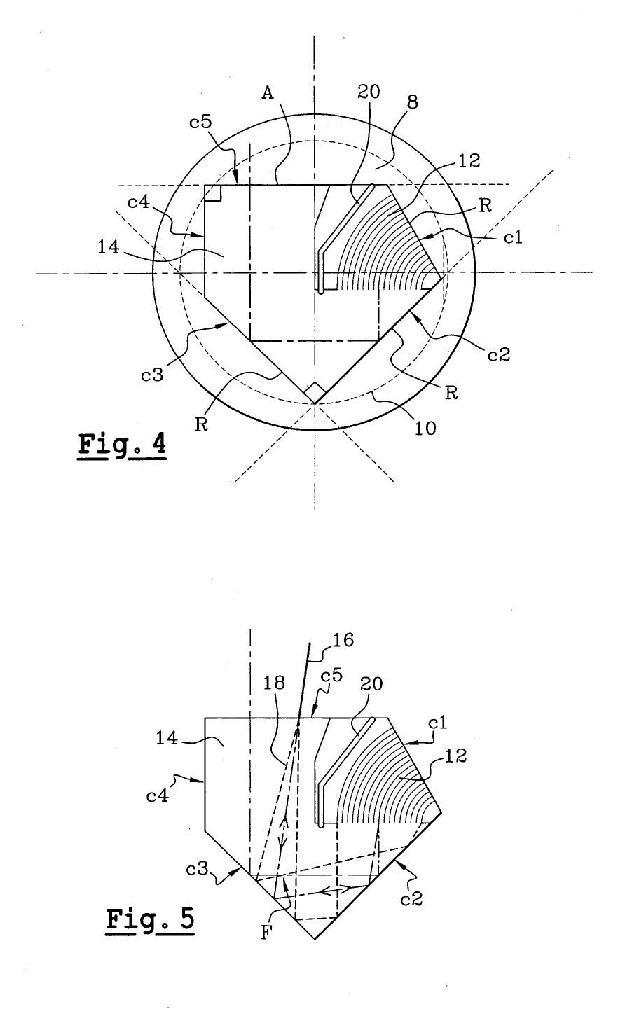

This technique is well adapted for realizing the component represented in FIG. 4. The method utilized is that of thermal exchange of ions such as Na⁺, K⁺, or Cs⁺, eventually assisted by an electrical field. This well-known technique consists in exchanging alkaline ions (for example, Na⁺ ions) already present in the glass with other ions such as Ag⁺ or Tl⁺ that have the effect of locally increasing the index of refraction of the glass.

The optical losses due to the fiber/guide connection and the attenuation in the guide have been considerably reduced by virtue of the embedded guides technique. This latter consists in diffusing the first doping in the substrate (under electrical field) or even in producing a second thermal diffusion of sodium ions. Thus one obtains guides characterized by sections of quasi-circular sections of doping, having a mode according to that of a monomodal optical fiber—modal coverage is optimized—and having considerably lower linear attenuations as a result of the quasi-disappearance of the surface diffusion: it is typically lower than 0.1 dB/cm.

Another advantage of this technique is the capability of producing guides having very low dependence vis-à-vis the polarization and thus having a less costly design: there is no more need for compensating the effects of birefringence by means of a semi-wave blade inserted in the middle of the microguide zone, for example.

Let us now consider the phasar masking schemes that can be used in the invention.

One may distinguish at least two masking schemes for the phasars.

The first masking scheme corresponds to a folded demi-phasar (functioning in reflection), with an input beam focusing zone in a guiding layer, said input beam coming from a optical fiber (see FIGS. 4 and 5).

The second masking scheme corresponds to a phasar functioning in transmission (and thus non-folded) without an integrated optics focusing zone: this focusing takes place in free space.

An adapted housing, represented in FIGS. 6A and 6B (respectively 7A and 7B), corresponds to the first (respectively second) masking scheme.

By way of example, FIG. 4 shows a folded demi-phasar mask according to the first masking scheme. The substrate used is a glass wafer 8 measuring 60 mm in diameter and 1.5 mm in thickness. The useful zone, delimited by a dotted circle 10, is restricted to a disk measuring 50 mm in diameter. The microguides 12 and the planar guide 14 are obtained by embedding the guiding layer.

By using the silica-on-silicon technology with a wafer measuring 6 inches (i.e., about 15 cm) in diameter, at least four demi-phasars of the type as represented in FIG. 4 can be produced per plate. For the wafers measuring 8 inches (i.e., about 20 cm) in diameter, it becomes possible to form eight demi-phasars of the type that is represented in FIG. 4 on a single substrate and thus further reducing the costs of manufacture.

Continuing by way of example, this semi-phasar comprises five cleaved and polished sides c1, c2, c3, c4 and c5. The sides c2 and c3 form an angle of 90° relative to each other; the sides c1 and c2 form an angle of 45°+60°=105° relative to each other; the sides c4 and c3 form an angle of 45°+90°=135° relative to each other; and the side c5 is perpendicular to c4.

By way of example, according to the specifications described hereinbefore and relative to a phasar operating at level 39 for a spectral range of 40 nm, 800 microguides 12 separated by 19.8 micrometers from each other form 60° arcs of a circle. The minimum radius of curvature is 4 mm and the maximum radius of curvature is 19.8 mm.

The focusing zone F, integrated on the planar guide 14 and delimited by the sides C₄, C₃ and c₂ (FIG. 5) makes it possible to extend all of the light coming from an optical fiber 16 (FIG. 5) over all of the microguides without supplementary focusing optics.

The numeric aperture of the monomodal optical fibers traditionally used in optical telecommunications is of the order of 0.15 to 0.17 in air, wherein a semi-angle of divergence of around 9° to 10° in air and approximately 6° to 7° in glass. The end of the fiber 16 is thus situated at around 55 mm from the interface of the microguides.

It is stated that this end of the fiber 16 is optically coupled to the planar guide by micro-positioning and adhesion (pigtail technique).

After cleaving and polishing, the sides c1, c2 and c3 must be comprised of reflectors. In order to do this, the side c1 at which the respective ends of the micro guides 12 abut orthogonally form concentric arcs of circles and optionally the sides c2 and c3 receive a reflecting deposit R that can be a metallization or, preferably, a dielectric multilayer whose spectrum of reflection is centered on the analyzed wavelength range.

Even if the sides c2 and c3 do not receive a reflecting deposit, the incident rays and their homologues that emerge from the phasar arrive on these sides at a angle sufficient so that there is reflection over the diopters that they constitute.

The side c5 can receive an anti-reflecting multi-layer deposit A (in the useful spectral band along the path going from glass to air).

The outputs of the microguides are distributed along a circle having a 250 mm radius corresponding to the diameter of the Rowland circle on which the image points are dispersed. A small distortion of the image (applied to a circle having a 125 mm radius) is thus observed on the flat bar of photodetectors used with the demi-phasar (see FIGS. 6A and 6B) and does not exceed one demi-pixel at the edge of the field, which allows a planeity correction in the spectral measurement.

Sides c2, c3 and c4 make it possible to fold the incident light beam 18 originating in the injection optical fiber 16 (FIG. 5). This beam 18 is then naturally extended over all inputs of the microguides. The fiber 16 is calibrated relative to the output field.

By way of example, the fiber 16 is a 125 μm monomodal optical fiber and has a 0.16 numerical aperture and this fiber can be arranged in proximity to the axis of the wafer and oriented at approximately 13° relative to this axis. The front of the incident wave is then calibrated relative to the front of the microguides and the wavelength λo defined hereinbefore corresponds then to the lowest wavelength of the spectrum and not to the central wavelength (corresponding to the case, wherein the fiber is placed at the center).

In FIGS. 4 and 5, the reference 20 designates a separator zone that results, for example, in the diffusion of chrome or cobalt (absorbance at 1.55 μm).

According to a second masking scheme (not shown), the phasar is similar to that which has been described in referring to FIGS. 4 and 5, except that it is not folded and thus operates in transmission. By way of example, it comprises four precisely cleaved and parallel sides two by two as well as a supplementary cleaved side. A first cleaved side corresponding to the input of the microguides forms an angle of 120° to a second cleaved side corresponding to the output of the microguides and the third and fourth cleaved sides are, respectively, parallel to the first and second cleaved sides.

The supplementary cleaved side connects the first cleaved side to the fourth and the cleavage of this supplementary side makes it possible to fit a cylindrical lens in the support of a micro-spectrometer utilizing this phasar as shown in FIG. 7A.

By way of exemplary embodiment, a spectrometer according to the invention is an assembly of several blocks of elementary micro-spectrometers as seen hereinbefore, each elementary micro-spectrometer making it possible to cover a spectral range of 40 nm. The overlap of several of these blocks makes it possible to cover a greater spectral range which is modulable depending on the applications.

Focusing of the output beam of the spectrometer can be done in different ways. It is possible to align several guiding layers by overlaying planar substrates connected with each other by 45° polishing forming a reflector prism or by a band of monomodal optical fibers.

Advantageously, the aforesaid assembly technique consists in arranging the planar substrate (comprising the phasar) and the reflector prism as well as the lens and the bar of photodetectors in a molded substrate or support, produced using a lithography and electro-forming molding process called the LIGA process (for the German, Lithographie Galvanoformung Abformung).

On the subject of this method, reference can be made to the following documents:

[8) J. Mohr, LIGA—A technology for fabricating microstructures and Microsystems, sensors and materials, Vol. 10, N^{o} 6, 1998, pages 363-373;

[9] J. Mohr et al., Micro-optical devices based on free space optics with LIGA micro-optical benches-examples and perspectives, SPIE 2783, 1996, pages 48-54;

[10] H. Nakajima et al., Micro-optical sensors fabricated by the LIGA process, SPIE 3513, 1998, pages 106-112.

The LIGA process makes it possible to fabricate in series and thus at optimized cost, elementary detection blocks; in other words, elementary micro-spectrometers.

According to this process, a metallic mold is formed by electro-forming (hence, electrolytic growth of the mold) after high-resolution lithography (of the order of 1 μm).

The LIGA X process, a special class of the LIGA process, consists of insulating a photoresist, for example PMMA, across a mask-membrane having a layer of gold that absorbs the x-rays. After dissolution of the insulated parts, a metal layer is deposited by electro-forming until covering the PMMA pattern and forming a mold that will be used to form the final parts by molding or hot-pressing of a hot plastic, these methods being adapted to mass production.

If, however, molding of the plastic is done on a metal substrate, a second electrolytic growth can make it possible to obtain a metal final product. Furthermore, hot-pressing of the plastic can be done on a ceramic substrate in order to reduce the thermal expansion of the final component.

The elementary spectrometer corresponding to a first assembly according to the invention (FIGS. 6A and 6B) utilizes the first masking scheme (see FIGS. 4 and 5). The planar substrate 22 having the demi-phasar, is placed with the guiding layer underneath and comprises the input focusing part (injection optical fiber 16-planar guide 14) integrated on the planar substrate 22.

After reflection by interface mirror (side c1 provided with a reflecting coating—see FIG. 4) at the output of the microguides 12, the light beam diffracted by these microguides is collected at the output of the planar guide 14 by a reflecting prism 24 then focused on a bar of photodetectors 26 by a cylindrical lens 28, whose focal distance is around 6 mm. Three mirrors 30, 32 and 34 makes it possible to reflect the beam towards the bar 26 over a distance of 140 mm in free space.

More precisely, the diffracted beam coming from the prism is reflected on the mirror 30 then on the mirror 32 that is perpendicular to said mirror 30 and then on the mirror 34 that is perpendicular to said mirror 32 and the mirror 34 reflects the beam towards the bar 26.

By taking into account the conjugation relation between the mode at the output of the planar guide and the image on the bar, the edge of the substrate is situated at a distance of 6.27 mm from the center of the lens for a focal distance of 6 mm. The height of the image beam over the photodetectors is approximately 120 μm.

In the example of FIGS. 6A and 6B, calibrated spacers 36, 38 and 40 that are disposed on the cleaved sides c1, c4 and c5, respectively, of the planar substrate 22, between these sides and the support 42 molded by the LIGA technique, make it possible to position this planar substrate at an elevated level and assure that it is parallel to the detection bar 26. The three mirrors 30, 32 and 34 as well as the bar 26 rest in notches, such as the notches 44 provided in the support 42. In the case of the ion exchange on glass method, the planar guide 14 is embedded at a known distance from the upper surface of the planar substrate 22, this surface serving as the reference.

The elementary spectrometer corresponding to a second assembly according to the invention (FIGS. 7A and 7B) uses the aforementioned second masking scheme. The planar substrate of this second assembly is also positioned with the guiding layer underneath.

Contrary to the first assembly, the focusing of the light coming from the monomodal optical fiber 16 is not done by integrated optics but in free space. In order to do this, the fiber is aligned passively in a groove 46. The support 48 for receiving the planar substrate 50 is formed using the LIGA process, provided with this groove 46 as well as all of the required notches.

By way of example, at the output of the monomodal fiber 16, the divergent light beam 52 (whose demi-angle of divergence is 8°) is filtered by a circular cover 54 then focused by a cylindrical lens 56 having a focal distance equal to 22 mm positioned at equal distance (22 mm) from the planar guide and from the fiber. The light beam is reflected towards the microguides 60 by a mirror 58 positioned at 35° and the fiber is inclined at 10°. The focusing parameters are defined by Gaussian optical conjugation relations for a guided mode having a waist of 2.2 μm.

The transmitted beam, diffracted by the microguides 60, is recuperated at the output of the planar guide by a reflecting prism 62 and then focused on the bar of photodetectors 64 by a cylindrical lens 66 having a focal distance of approximately 8 mm. This lens 66 can be a plano-convex lens or a Fresnel lens.

By taking into account the conjugation relation between the output mode of the planar guide and the image on the bar, the edge of the planar substrate 50 is at a distance of 8.5 mm from the center of the lens 66 for a focal distance of 8 mm. The height of the image beam is about 100 μm over the photodetectors.

Three mirrors 68, 70 and 72 make it possible to reflect the beam towards the bar over a distance of 175 mm in open space. More precisely, the diffracted beam coming from the prism 62 is reflected on the mirror 68 then on the mirror 70 and then on the mirror 72 and this latter mirror reflects the beam towards the bar 64.

By way of example, by taking as the reference the vertical (interface of the planar substrate), the first mirror 68 forms an angle of 15°, the second mirror 70 forms an angle of 75° and the third mirror 72 forms an angle of 48.75° (its normal being oriented at 41.25° to vertical).

In the case of FIGS. 7A and 7B, in the same fashion as for the first assembly, the calibrated notches 74, 76 and 78 that are disposed on the cleaved sides of the planar substrate 50, between its sides and the molded support 48, as can be seen in FIG. 7A, make it possible to position this planar substrate 50 in elevation and to assure that it is parallel not only to the detection bar 64 but also to the part of the fiber that is in the groove 46 and to the axis of the cylindrical lens 56.

An elementary micro-spectrometer according to the first assembly (FIGS. 6A and 6B) is capable of occupying a volume of 60×60×9 mm³.

According to the second assembly (FIGS. 7A and 7B), it is capable of occupying a volume of 60×60×12 mm³.

A micro-spectrometer comprising a stack of four elementary blocks makes it possible to cover a spectral range of more than 150 nm (at a wavelength of 1.55 μm) by overlaying according to the following distribution:

| | Spectral Range | Number of |
|---|---|---|
| Band | (nm) | Blocks |
| S | from 1470 to 1500 | 1 |
| C | from 1528 to 1565 | 1 |
| L | from 1566 to 1645 | 2 |

We will now consider temperature stability of a spectrometer according to the invention.

A phasar is sensitive to temperature regardless of the technology used to fabricate it. This is translated by variations in the central wavelength λo of the phasar as a function of temperature, these variations result in thermal expansion of the phasar material and variations of the index of refraction of this material as a function of the temperature (thermo-optic effect). The central wavelength increases with temperature.

For an aforementioned phasar operating at level 39 for a spectral range of 40 nm, produced using integrated optics on silicon or integrated optics on glass, the thermal dependence on the central wavelength is of the order of 10 pm/° C. The result is an offset of the spectrum on the photodetector bar of the order of 3 μm/° C.; that is, a quarter pixel/° C.

Each of the two proposed assemblies (FIGS. 6A-6B and 7A-7B) can be temperature regulated by a heating resistor in order to assure the stability of the spectral measurements in time and the tightness of the assembly can be foreseen in order to assure the resistance of this assembly to humidity and also guarantee constant air pressure.

Another solution consists in providing a mechanical compensation element for this angular offset.

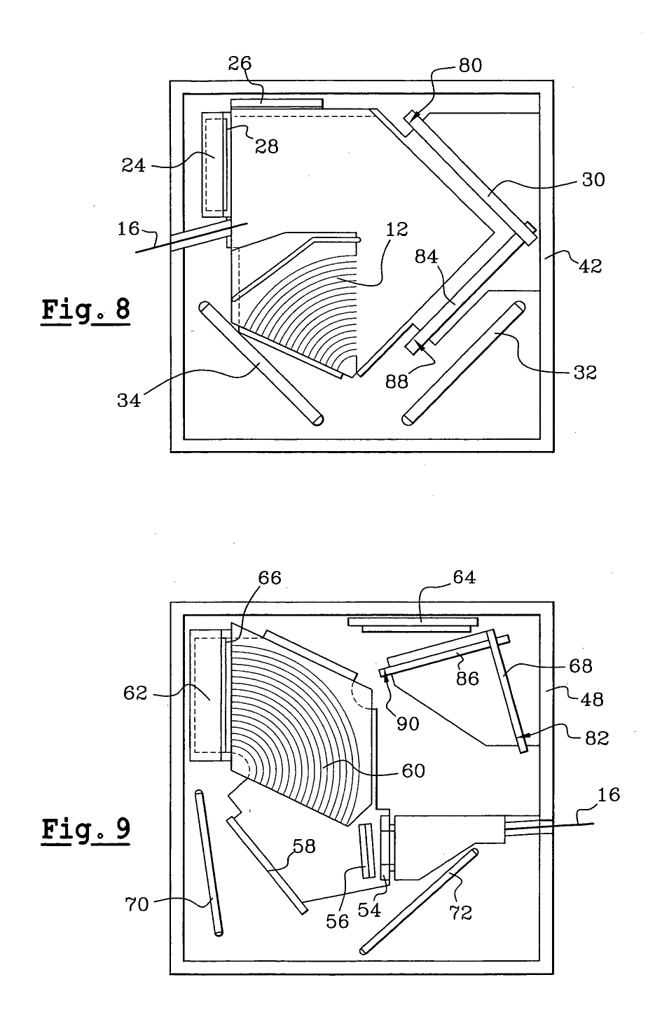

In the case of spectrometers in FIGS. 6A-6B and 7A-7B, a compensation solution consists in actuating one of the “folding” mirrors of the output beam, advantageously the first mirror 30 (FIG. 6A) or 68 (FIG. 7A) although this principle can be adapted to each of the mirrors. This mirror 30 or 68 is engaged by one of its ends in a positioning groove 80 (FIG. 8) or 82 (FIG. 9) that serves as a pivot and this mirror 30 or 68 is actuated by a lever arm 84 (FIG. 8) or 86 (FIG. 9) affixed to the other end of the mirror.

By way of example, this lever arm is an aluminum bar, engaged in a groove 88 or 90, whose coefficient of thermal expansion is around 23×10⁻⁶/° C. The extension by thermal expansion of this bar inclines the mirror and compensates the angular offset induced by temperature variation in the planar substrate. An inclination of approximately 2.5×10⁻⁵ rad/° C. is necessary and produced, for example, by a 20 mm long bar placed at 20 mm from the pivot according to FIGS. 8 and 9 that correspond, respectively, to the first and second assemblies.

As concerns the sensitivity of the measurements, the total distance traveled by the light in the spectrometer is of the order of 10 cm, wherein a propagation loss of 1 dB (taking into account a 0.1 dB/cm attenuation). These connector engineering losses and the losses at interfaces must be added. We thus consider a total optical loss of the spectrometer of 6 dB.

In the case of utilization of this spectrometer for measuring wavelengths of Bragg gratings in optical metrology, the majority of the continuous superluminescent sources utilized typically emit several tens of nm of spectral width. This corresponds to a spectral density of excitation of the order of 100 μW/10 nm; that is, 1 μW/Å.

Knowing that the spectral width typical of a transducer Bragg grating is of the order of 1 Å0 (100 pm), the power sent by the external optical fiber is then equal to approximately −30 dBm (1 μW). Thus, the power analyzed at the level of the bar of photodetectors is estimated at −42 dBm (by taking into account optical losses and spot/pixel overlap).

An external optical fiber is connected to the planar guide 14 (FIG. 5) in order to be otherwise welded or connected to the optical circuit incorporating one or a plurality of sensitive optical fibers. This external fiber thus constitutes the optical interface with the exterior milieu (accessible by the end user).

Advantageously, this external optical fiber is monomodal at the wavelength of utilization (typically 1300 nm, 1550 nm or even 820 nm).

The fibe-guide connection can be assured by the V-grooves technique.

The connection of the fibers to the guides can be made by gluing (for example with an ultraviolet radiation polymerizable glue) or by laser welding.

Advantageously, the detection unit is an assembly of photodiodes or a bar of photodiodes made of InGaAs produced by epitaxy. Bars such as these and commercially available from Thomson can be used. The useful zone of detection is about 5 μm; it is separated by two 8 μm passivated zones, wherein a period of 13 μm.

A strong frequency pass-band (100 kHz) can be achieved by operating the photodiodes in photoconductor regime and by inserting these diodes into an electronic installation of the transimpedence type, for example.

In the alternative, in the case of integrated optics on silicon technology, the photodetectors can be incorporated directly in the circuit.

A photodetector array making possible forming images in two dimensions can also be utilized in lieu of several linear bars.

As relates to calibrating, a correction polynomial between pixel and wavelength is generally used as a result of the field distortion observed on the bar.

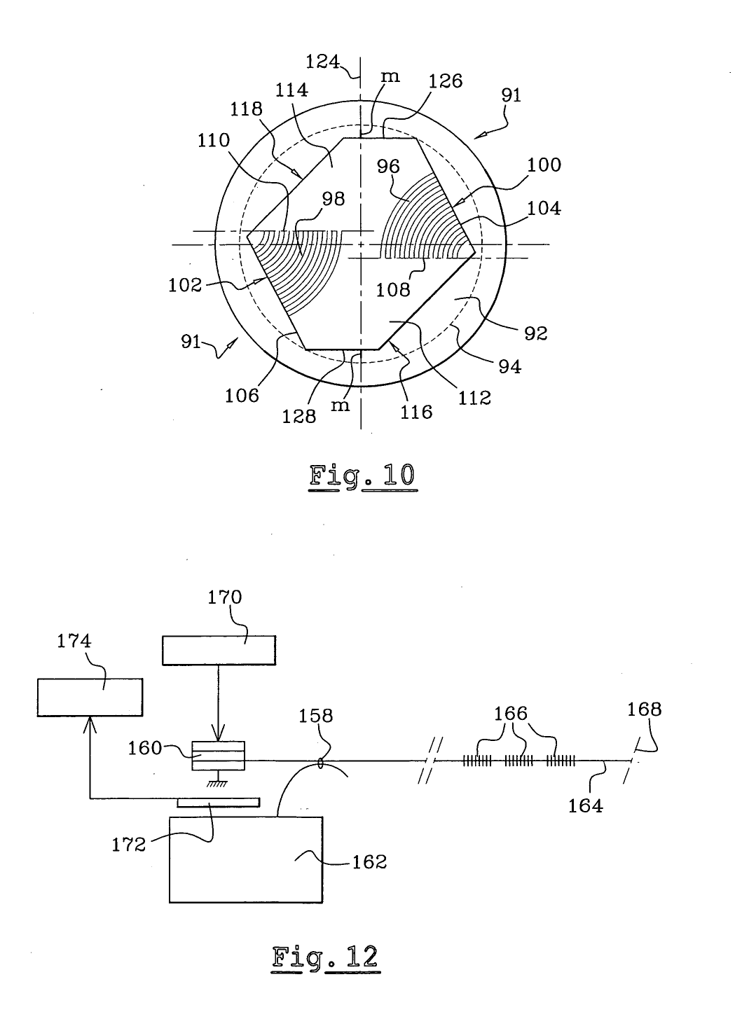

We propose also a third assembly according to the invention incorporating an integrated optics component, represented diagrammatically in FIG. 10 having a more reduced surface in order to optimize its manufacturing cost. It is a reflection demi-phasar.

Two identical demi-phasars 91 functioning in reflection can be produced on the same disk 92 having a diameter of 60 mm (the dotted circle 94 delimiting the useful zone of the disk 92).

In a fashion similar to FIG. 4, an assembly 96 (respectively 98) of 800 microguides forming 60° arcs of a circle is delimited on one side by a cleavage 100 (respectively 102), the side resulting from this cleavage being equipped with a reflecting deposit 104 (respectively 106) and on the other side with an interface 108 (respectively 110) towards a planar guiding layer 112 (respectively 114) allowing reflection of the light beam by virtue of another cleavage 116 (respectively 118).

Contrary to the first assembly, a reflecting deposit is not necessary on the cleavage 116 (respectively 118) because, in the example of FIG. 10, the angle of incidence is sufficient so that there is total reflection for the incident and refracted beams.

The two demi-phasars are initially separated by a cleavage 124 before any other operation.

In order to facilitate this cleavage operation of the markers marking the axis of this cleavage, for example, marks m at the two ends of this axis can advantageously be photo-etched at the same time as masking for diffusion of the guide.

A top cleavage 126 and a bottom cleavage 128 are also formed for mechanical reasons, as can be seen in FIG. 10.

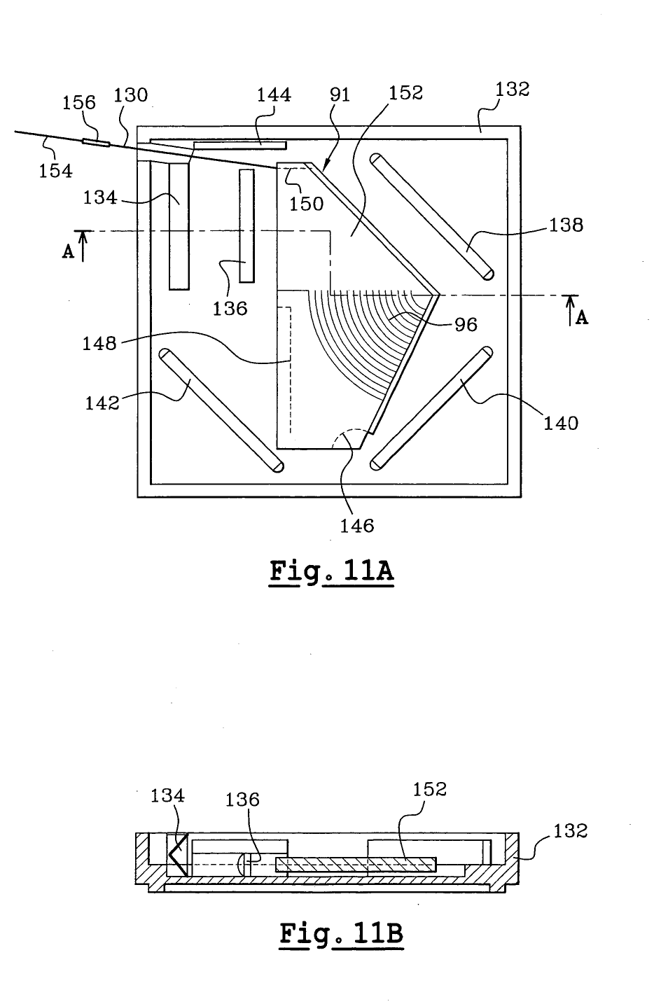

In the same manner as for the first assembly (FIGS. 6A and 6B), the third assembly diagrammatically represented in FIGS. 11A and 11B incorporates the optical component 91 describes, referring to FIG. 10, a optical fiber 130 connected to this component by conventional techniques and a mechanical support 132, molded by the LIGA process and supporting all of the optical elements (reflecting prism 134, cylindrical lens 136, flat folding mirrors 138, 140 and 142 and photodetector bar 144).

It is stated that in this assembly the light coming from the optical component 91 is reflected by the reflector prism 134 then focused by the cylindrical lens 136 on the photodetector bar 144 after reflection on the flat folding mirrors 138, 140 and 142.

The optical principle of this assembly is identical to that of the first assembly (FIGS. 6A and 6B). The cylindrical lens 136 is, however, placed between the reflector prism 134 and the planar optical component 91 but the distance between the lens and this component is the same as for the first assembly.

This component is also based on three spacers 146, 148 and 150.

It should be noted that in each of the spectrometers of FIGS. 6A-6B, 7A-7B and 11A-11B, the light that is to be analyzed is guided over a portion of its path, into a planar guide, comprising micro guides 12 or 60 or 96 then another part of this path is in free space, after folding of this path by virtue of the prism 24 or 62 or 134, this folding making it possible for the light to be substantially in a plane parallel to the planar guide, then this path in free space is again folded several times in this plane by virtue of the mirrors 30-32-34 or 68-70-72 or 138-140-142 before reaching the photodetectors, which makes it possible to confine the total path in a very low volume and obtain the spectrometers that require very little space.

However, it would not be departing from the context of the invention by reducing the number of folds and by reducing, in order to do this, the number of mirrors and/or by suppressing the prism; one would still achieve spectrometers requiring less space than the prior art; in the case of FIGS. 6A-6B and 7A-7B, the suppression of the prism would of course require placing the lens facing the planar guide so that it can focus the light leaving it.

In returning to FIGS. 11A and 11B, the optical fiber 130 is advantageously made of germano-silicate, its core has a very small diameter (around 2 micrometers) and it has a very large index jump (greater than or equal to 0.05). This fiber is assembled on the planar substrate 152 of the component 191 by gluing. The fibers of this type are utilized for the non-linear optics or the optical amplification, applications for which a very high light intensity is sought.

This optical fiber 130 is welded to another optical fiber 154, of the type of those that are utilized in telecommunications in the wavelength band of 1.55 micrometers. These fibers have a core of the order of 9 micrometers in diameter and an index jump of about 5×10⁻³.

An adaptation of the mode of the fiber 130 to the mode of the fiber 154 is done in order to weld these fibers 130 and 154 with a minimum of loss. In order to do this, the fiber 130 is locally heated in order to diffuse the dopant (the germanium in the example under consideration) towards the outside and thus to create a progressive variation of the diameter of the core until it adapts to that of the fiber 154. This technique is known under the name of TEC for thermally-diffused expanded core.

The optical fiber 130 thus comprises, at one end, a portion of the diffused core 156 fiber on which the fiber 154 is welded in conventional fashion.

Four examples of application of the invention-will now be described.

1) Analysis of the ITU grid-compatible high-speed DWDM optical spectra.

In this range, a spectrometer according to the invention makes it possible to provide the user with a visual indication of the optical position of the DWDM channels. It is foreseeable to provide counter-reaction signals to laser diode control modules in order to correct any deviation of the wavelengths of the emitters. This control means corresponds to pixel-by-pixel addressing. It makes possible producing a dynamically reconfigurable multiple-channel receiver.

This type of spectrometer is compatible with the future DWDM specifications. It is characterized by low space requirements, optimized cost (resulting from collective manufacture) and a large pass-band, that runs typically from a few kilohertz to a few hundred kilohertz and depends only on photodetectors with or without analysis of the polarization state.

It modular aspect (resulting from the multi-stage design) makes it possible to address wholly or in part the optical spectrum used in long distance telecommunications, this spectrum extending from 1300 nm to 1700 nm.

2) Measurement of the signal-to-noise ratio of the optical channels in the DWDM telecommunications networks.

This relates to measuring the power of each channel as well as the ambient noise induced especially by the amplified spontaneous emission (ASE) of the amplifiers. By virtue of the separator power of a micro-spectrometer according to the invention, it is possible to determine the envelope curve of base optics noise of the channels for interpolating the noise values for each channel wavelength and deducing the signal-to-noise ratio for each of the channels as described in the following document:

[11] WO 98/54862 (CIENA Corp.).

3) Spectral measurement of the dispersion of polarized modes.

The monomodal fibers used support two polarized modes resulting from the birefringence of the silica. These two modes are characterized by two slightly different effective indices. The light pulse received is formed from two pulses according to two polarized states whose delay develops over time, especially due to constraints in the optical cables, said constraints resulting from temperature variations, for example.

Chromatic dispersion has been limiting the temporal multiplexing for a long time. Currently, the polarized mode dispersion (PMD) constitutes a novel limitation in terms of modulation capacity.

Two statistical behavior states are distinguished for PMD. In the one state, the PMD is proportional to the length L of the fiber, whilst in the other state it is proportional to L^{1/2} In practice, a 100 km: line having a transmission capacity of 10 Gbits requires a coefficient of PMD of less than 1 ps·km^{1/2} and it becomes important to characterize this parameter on the ground. The usual values for PMD are thus a few tens of ps over several hundreds of kilometers of fiber.

Among all of the methods known for measuring the PMD, there exists one that employs a broad spectral band source, alternatively polarized in two orthogonal directions and according to which the corresponding spectra of the transmitted light beam through an analyzer are collected and the number of passages are counted by the 0 dB of the ratio curve of the two spectra. On this subject, reference is made to the following document:

[12] C. D. Poole et al., Polarization-mode dispersion measurement based on transmission spectra through a polarizer, J. of Lightwave technol., Vol. 12, N^{o} 6, 1994, pages 917-929.

With this method, the high PMD values (corresponding to the measurement range) are defined by the spectral resolution of the spectrometer that are used, when the low PMD values are defined by the spectral range of the observed spectrum.

4) Analysis of Bragg grating spectra for Bragg grating metrology.

For such an analysis, a broad banded source is used and the wavelengths reflected by the different Bragg gratings multiplexed in wavelengths along the measurement line are analyzed. The measurement and demultiplexing is done simultaneously by addressing on a photodetector bar according to an optimized cost and using a strong frequency pass-band, all of the parameters being important in order to be able to utilize this type of metrology in the industrial environment.

The spectral behavior equation for a Bragg grating inscribed in a standard germano-silicate fiber is written:

$$\frac{Δλ}{λ} = 0.78 ϵ + 7.4 \times {10}^{- 6} Δ T ( ° ) - 5.2 \times {10}^{- 6} Δ P ( MPa ) .$$

In this equation ε, ΔT and ΔP correspond, respectively, to the deformation, to the temperature difference, and to the pressure difference.

For an excitation source, whose half-maximum width is about 48 nm, this corresponds to multiplexing 8 Bragg transducers on the measurement line.

Thus an optical micro-system for measuring deformations or temperatures can be designed, comprising Bragg grating transducers photoinscribed as shown diagrammatically in FIG. 12. One such micro-system can comprise, in addition, a quadruple path equilibrated coupler (with 50% of transmission over the two output paths) of reference 158 in FIG. 12.

A wide spectral band optical source 160 that can be a source of erbium doped fiber superfluorescence or even a superluminescence diode is then connected to an input arm of the coupler 158, while the micro-spectrometer 162 according to the invention is connected to the other input arm of the coupler. One of these two output arms of the coupler is connected to the end of a sensitive optical fiber 164, on which a plurality of Bragg grating transducers 166 are photo-inscribed and whose other extremity comprises a biased cleavage 168.

It will be recalled that the optical spectrum of the superluminescent diodes has a Gaussian appearance and a typical spectral width of the order of 30 nm to 50 nm.

It will also be seen in FIG. 12, the supply means 170 of the source 160, the photodiode bar 172 that is associated with the micro-spectrometer and the electronics means 174 for detecting the signals provided by the photodiode bar.

A device according to the invention is thus applied to real-time monitoring, with high pass-band (1 kKz), of several constraints or pressures applied to a sensitive optical fiber incorporated into a structure, for example, made of composite material.

It can also be employed to make real-time measurements of distributed temperatures.

In addition, it can be used in the field of telecommunications for demultiplexing several channels and measuring coded information on wavelength.

This device is applied also to demultiplexing and to measurement of several wavelengths, for example, in the field of multiplexed telecommunications on wavelength.

Finally, according to a first multiplexing embodiment, the great flexibility in manufacturing of this device makes it particularly attractive for multisector instrumentation, by facilitated adjustment of Bragg wavelength of the photo-inscribed Bragg gratings, addressing being thus done via the photodetector bar.

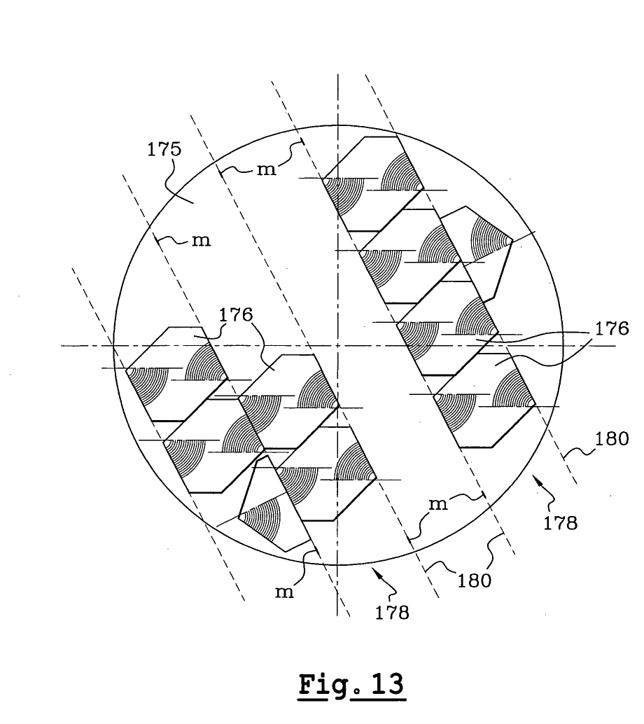

We will now consider a collective manufacturing method for phasars that can be used in the invention by making reference to FIG. 13.

This type of phasar can be manufactured by using a silica-on-silicon integrated optics technology and a 4-inch (approximately 10 cm) diameter wafer. Using this technology one can also treat 8-inch (approximately 20 cm) diameter wafers. It is possible to form 16 double-phasars 176 of the type that is shown in FIG. 10 and thus 32 phasar components simultaneously (collective manufacturing approach) on such a support 175 (FIG. 13).

After producing patterns (according to the methods described in documents [4) and [5]), the assemblies 176 are separated by sawing (by means of a metal slab or a diamond slab) using an automatic numerically controlled process. The saw mark is approximately 200 μm to 300 μm in width; it is not represented in FIG. 13.

The sawing operation can be started by a separation of bands 178 of double phasars 176, for example, along dotted lines 180 and then following by assembling of the bands so separated and in recutting of these same for isolating the double phasar 176 patterns. The phasars can then be re-assembled and cut along their center line (not shown).

The economic advantage of this folded phasar scheme aims at dividing the surface of the component in half relative to a conventional scheme on transmission. The number of phasar components manufactured by cutting is thus multiplied at least by two and the cost of an individual phasar is divided at least by two.

Furthermore, the polishing operations that follow the sawing operation can be produced simultaneously on a very large number of substrates, which thus makes it possible to reduce costs further. It is the same for the operation of formation of the reflecting deposit mentioned hereinbefore in the description of FIGS. 4 and 5.

Cleavage marks m can still be formed as described hereinbefore for defining the different cleavage marks required, especially the cleavage marks 180.

1. An optical spectrometer comprising at least one elementary optical spectrometer, said elementary optical spectrometer being characterized in that it comprises:
an optical phase array comprising a microguide assembly (12, 60, 96, 98), said optical phase array being formed on a planar optical guide that is cleaved;
reflecting means (24, 30, 32, 34; 62, 68, 70, 72; 134, 138, 140, 142) capable of successively reflecting radiation coming from the microguide assembly, with a view to a propagation of said radiation in folded form and in free space;
means (26, 64, 144) for photodetecting the radiation so reflected, and
means (28, 66, 136) for focusing the radiation onto said photodetection means.

2. The spectrometer according to claim 1, wherein the reflecting means are capable of making possible the propagation of the radiation in folded form, initially into the planar optical guide and then into free space, over said planar optical guide, in a plane that is parallel to the latter.

3. The spectrometer according to any one of claims 1 and 2, wherein the optical phase array is intended to function by reflection and the planar optical guide comprises a plurality of cleaved sides (c1, c2, c3), made reflecting vis-à-vis radiation coming from the microguide assembly and vis-à-vis the radiation intended to penetrate into said assembly.

4. The spectrometer according to claim 3, wherein the microguide assembly abuts on one (c1) of the cleaved sides and the optical phase array comprises a focusing zone (F) that abuts on at least one of said cleaved sides.

5. The spectrometer according to any one of claims 1 and 2, wherein the optical phase array is provided for functioning by reflection and the planar optical guide comprises a cleaved side (c1) that is made reflecting vis-à-vis radiation coming from the microguide assembly and vis-à-vis the radiation intended to penetrate into said assembly and at which the microguide assembly abuts, as well as other cleaved sides (c2, c3) capable of reflecting said radiation, said radiation being provided for arriving on said other cleaved sides with angles of incidence that are sufficiently large to result in total reflection of said radiation.

6. The spectrometer according to any one of claims 1 to 5, wherein the microguides form concentric arcs of circles (12, 96, 98).

7. The spectrometer according to any one of claims 1 and 2, wherein the phase array is provided to function by transmission.

8. The spectrometer according to any one of claims 1 to 7, wherein the reflection means comprise:
a prism (24, 62, 134) that is provided for reflecting the radiation coming from the microguide assembly into a plane parallel to the planar optical guide on which the optical phase array is formed, and
at least one mirror (30, 32, 34; 68, 70, 72; 138, 140, 142) provided for reflecting the radiation propagated in said plane towards the photodetection means.

9. The spectrometer according to any one of claims 1 to 8, comprising in addition a support (42, 48, 132) on which the optical phase array, the reflecting means and the photodetection means are positioned each relative to the others.

10. The spectrometer according to claim 9, wherein the support (42, 48, 132) is obtained by molding or hot-pressing a plastic material using a mold obtained by a lithography and electro-forming molding process.

11. The spectrometer according to any one of claims 1 to 10, comprising in addition means (84, 86) for compensation of changes undergone by the optical phase array due to changes in temperature.

12. The spectrometer according to claim 8, comprising in addition means for compensation of changes undergone by the optical phase array due to temperature variations, said compensation means comprising a bar (84, 86) having preferably an elevated thermal expansion coefficient, said bar and mirror (30, 68) being made interdependent in order to cause, by thermal expansion, changes in the orientation of the mirror capable of compensating the changes undergone by the optical phase array.

13. The spectrometer according to any one of claims 1 to 12, wherein the planar optical guide is obtained by an integrated optics method on glass or on a semiconductor, in particular on silicon or indium phosphide.

14. The spectrometer according to any one of claims 1 to 13, comprising a plurality of elementary optical spectrometers (M1, M2, M3; M1x, M1y, M2x, M2y, M3x, M3y) to modularly cover a defined spectral range and optically coupled to an input optical fiber (FE) by means of wavelength separation means (2, 4).

15. The spectrometer according to claim 14, comprising in addition polarization separation means (C1, C2, C3) that connect the wavelength separation means to the elementary optical spectrometers.

16. The spectrometer according to claim 14, comprising in addition power separation means (P1, P2, P3) and polarization means (Px, Py) that connect the wavelength separation means to the elementary optical spectrometers.

17. A method for manufacturing the spectrometer according to claim 1, wherein the optical phase array is of the folded type in order to function by reflection and fabricated in several copies, in head-to-foot pairs, according to integrated optics methods, using a same substrate that is then cleaved in order to obtain the various optical phase arrays so fabricated and to form an elementary optical spectrometer using each of these.

18. A method for manufacturing the spectrometer according to any one of claims 1 to 16, wherein each optical phase array is formed using a substrate and cleavage marks (m) are formed at the same time as the microguides of said optical phase array on said substrate.

19. A device for spectral analysis for high-speed optical telecommunications utilizing a dense wave division multiplexing, said device comprising the spectrometer according to any one of claims 14 to 16 in order to provide an indication in real time of the positioning of channels in the interval ranging from 1528.77 nm to 1563.86 nm in a modular manner and adaptable to the needs of the users.

20. A Bragg grating optical metrology device, said device comprising the spectrometer according to any one of claims 14 to 16 for measuring Bragg wavelengths.

21. The device according to claim 20, wherein the spectrometer is intended for detecting optical signals coming from at least one Bragg grating sensor (166).
